(19) United States
(12) Patent Application Publication
(10) Pub. No.: US 2026/0045390 A1
(43) Pub. Date: Feb. 12, 2026

(54) MAGNET MATERIAL FOR BONDED MAGNET AND MAGNET

(71) Applicant: Murata Manufacturing Co., Ltd., Nagaokakyo-shi, Kyoto-fu (JP)

(72) Inventors: Takashi YAMAZAKI, Nagaokakyo-shi, Kyoto-fu (JP); Kazuhiro TAKAYAMA, Nagaokakyo-shi, Kyoto-fu (JP)

(21) Appl. No.: 18/591,731

(22) Filed: Feb. 29, 2024

Related U.S. Application Data
(63) Continuation of application No. PCT/JP22/34095, filed on Sep. 12, 2022.

(30) Foreign Application Priority Data
Sep. 10, 2021 (JP) 2021-148157

(51) Int. Cl. H01F 1/057; H01F 7/02

(52) U.S. Cl. CPC H01F 1/0578; H01F 7/02

(57) ABSTRACT

A magnet material that includes: a RE₂Fe₁₄B tetragonal compound as a main phase, the RE₂Fe₁₄B tetragonal compound has an average crystal grain size of 10 nm or more and less than 70 nm; and an amorphous and magnetic grain boundary phase surrounding the main phase, the amorphous and magnetic grain boundary phase containing F, RE, Fe, and B, wherein the RE is at least one rare-earth element containing at least Nd among Nd and Pr.

### CROSS REFERENCE TO RELATED APPLICATIONS

The present application is a continuation of International application No. PCT/JP2022/034095, filed Sep. 12, 2022, which claims priority to Japanese Patent Application No. 2021-148157, filed Sep. 10, 2021, the entire contents of each of which are incorporated herein by reference.

### TECHNICAL FIELD

The present invention relates to a magnet material for a bonded magnet and a magnet.

### BACKGROUND ART

PTL 1 discloses a magnet having improved coercive force by applying a heavy rare-earth fluoride to a surface of a bulk body of a sintered magnet and performing heat treatment thereon to diffuse the heavy rare earth in the magnet and surround and cover the main phase by a phase containing the heavy rare-earth. PTL 2 discloses a magnet having improved coercive force by applying a rare-earth metal compound having a low melting point to a surface of a bulk body of a hot-deformed magnet and performing heat treatment thereon to diffuse the rare earth in the magnet.
PTL 1: Japanese Patent No. 4450239
PTL 2: Japanese Patent Laid-Open No. 2015-82626

### SUMMARY OF THE INVENTION

However, since the step of performing the heat treatment onto the bulk body is included with regard to each of the magnet materials described in both the pieces of patent literature, the magnet material is not usable for a bonded magnet in which a resin of the bulk body is modified and melted by the heat treatment. Therefore, there has been a demand for a magnet material for a bonded magnet that exhibits high intrinsic coercive force. The present invention has been made to solve the above-described problem and provides a magnet material for a bonded magnet and a magnet that each exhibit high intrinsic coercive force HcJ.

A magnet material for a bonded magnet according to the present invention includes: a RE₂Fe₁₄B tetragonal compound as a main phase, the RE₂Fe₁₄B tetragonal compound has an average crystal grain size of 10 nm or more and less than 70 nm; and an amorphous and magnetic grain boundary phase surrounding the main phase, the amorphous and magnetic grain boundary phase containing F, RE, Fe, and B, wherein the RE is at least one rare-earth element containing at least Nd among Nd and Pr.

In the magnet material for a bonded magnet, a width of the grain boundary phase is preferably 1 nm to less than 10 nm.

In the magnet material for a bonded magnet, a content of the main phase is preferably 70 volume % to 99 volume %, and a content of the grain boundary phase is preferably 1 volume % to 30 volume %.

A magnet according to the present invention includes: a binder; and any of the above-described magnet materials for a bonded magnet dispersed in the binder.

According to each of the magnet material for a bonded magnet and the magnet according to the present invention, high intrinsic coercive force HcJ can be exhibited.

### BRIEF DESCRIPTION OF THE DRAWINGS

FIG. 1 is a cross sectional view schematically showing an exemplary magnet material of the present invention.

FIG. 2 shows a powder X-ray diffraction profile of a rapidly solidified alloy obtained in an Example 5.

FIG. 3(a) is an apparatus configuration diagram of a heat treatment furnace that implements flash annealing, and FIG. 3(b) is a diagram showing a state of the rapidly solidified alloy that is moved inside a furnace core tube.

FIG. 4 is a conceptual diagram of thermal history by the flash annealing performed in the present invention.

FIG. 5 shows a powder X-ray diffraction profile of the rapidly solidified alloy obtained in Example 5 after the flash annealing (crystallization heat treatment).

FIG. 6 shows bright-field image and element mapping when a magnet material obtained in an Example 1 is observed using a transmission electron microscope.

FIG. 7 shows bright-field image and element mapping when a magnet material obtained in an Example 2 is observed using a transmission electron microscope.

FIG. 8 shows bright-field image and element mapping when a magnet material obtained in an Example 3 is observed using a transmission electron microscope.

FIG. 9 shows bright-field image and element mapping when a magnet material obtained in a Comparative Example is observed using a transmission electron microscope.

### DETAILED DESCRIPTION OF THE PREFERRED EMBODIMENTS

Hereinafter, a magnet material for a bonded magnet and a magnet according to the present invention will be described. It should be noted that the present invention is not limited to below-described configurations and may be appropriately modified without departing from the gist of the present invention. Further, a combination of a plurality of individual preferable configurations described below is also included in the present invention.

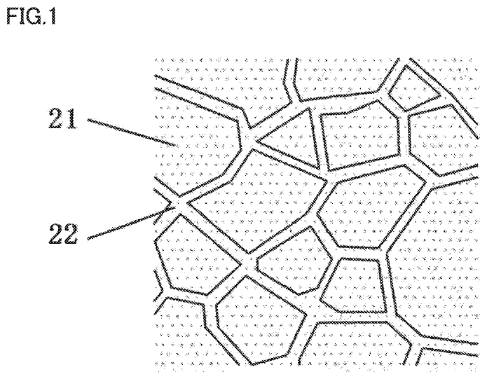

A magnet material for a bonded magnet according to the present invention includes: a RE₂Fe₁₄B type tetragonal compound as a main phase; and a grain boundary phase containing F, RE, Fe, and B, the grain boundary phase being amorphous, the grain boundary phase having a structure surrounding the main phase, wherein the RE is at least one rare-earth element containing at least Nd among Nd and Pr. FIG. 1 is a cross sectional view schematically showing an exemplary magnet material. As shown in FIG. 1, in this magnet material, a main phase 21 is surrounded by a grain boundary phase 22. It should be noted that when a magnet material is produced using a strip casting method, a mold casting method, a centrifugal casting method, or the like to have a similar composition containing at least F and B, a crystalline substance containing F (and containing no or small amount of B) or a grain boundary phase containing the crystalline substance is generated, with the result that it is impossible to realize a state in which the grain boundary phase uniformly covers the main phase as in the present invention. This is due to the following reason: in order to form the grain boundary phase as in the present invention, it is necessary to employ a melt spinning method, which is a rapid cooling method suitable to manufacture a bonded magnet having a fine structure (for example, a structure in which the main phase has an average crystal size of less than 70 nm) as described later. Hereinafter, details will be described.

### [Alloy Composition]

An alloy composition of the magnet material for a bonded magnet according to the present invention is not particularly limited as long as the RE₂Fe₁₄B type tetragonal compound serves as the main phase and the grain boundary phase containing F, RE, Fe, and B is amorphous and has a structure surrounding the main phase as described above; however, for example, the alloy composition can be expressed by a composition formula of T_{100-x-y-z}(B₁₋ₙCₙ)ₓRE_{y}M_{z} (T is at least one transition metal element that is selected from a group consisting of Fe, Co and Ni and that necessarily contains Fe; RE is at least one rare-earth element containing at least Nd among Nd and Pr; and M is at least one metal element selected from a group consisting of Al, Si, V, Cr, Ti, Mn, Cu, Zn, Ga, Zr, Nb, Mo, Ag, Hf, Ta, W, Pt, Au and Pb), and composition ratios x, y and z can satisfy 4.2 atomic %≤x≤5.6 atomic %, 11.5 atomic %≤y≤13.0 atomic %, 0.0 atomic %≤z≤5.0 atomic %, and 0.0≤n≤0.5. It should be noted that the composition of the magnet material according to the present invention is analyzed using an ICP mass spectrometry method or a combustion ion chromatography method. A combustion-infrared absorption method may be used in combination as required.

Transition metal element T containing Fe as an essential element occupies a remainder of the contents of the above-described elements. A desired hard magnetic property can be obtained also when one or two of Co and Ni, which are ferromagnetic elements as with Fe, substitute for part of Fe. However, when an amount of substitution for Fe is more than 30%, a magnetic flux density is significantly decreased, so that the amount of substitution is preferably in a range of 0% to 30%. It should be noted that since addition of Co not only contributes to improvement of magnetization but also has an effect of lowering viscosity of a molten metal to stabilize a rate of exiting from a nozzle when rapidly cooling the molten metal, the amount of substitution of Co is more preferably 0.5% to 30%, and is further preferably 0.5% to 10% from the viewpoint of cost-benefit performance.

In the magnet material for a bonded magnet according to the present invention, for example, when a composition ratio x of B+C is less than 4.2 atomic %, a necessary amount of B+C to generate the RE₂Fe₁₄B type tetragonal compound may be unable to be secured to result in decreased magnetic properties and greatly decreased amorphous generation ability, and accordingly an α-Fe phase may be precipitated during the rapid solidification of the molten metal, with the result that the squareness of the demagnetization curve may be impaired. On the other hand, when composition ratio x of B+C is more than 5.6 atomic %, the grain boundary phase containing RE and Fe as main components may not be generated, with the result that the above-described magnetic properties may be unable to be secured. Therefore, composition ratio x is preferably in a range of 4.2 atomic % to 5.6 atomic %. Composition ratio x is preferably 4.2 atomic % to 5.2 atomic %, and is more preferably 4.4 atomic % to 5.0 atomic %.

In the magnet material for a bonded magnet according to the present invention, since the melting point of the molten alloy is lowered with C substituting part of B to reduce an amount of wear of a refractory material used during the rapid solidification, process cost for the rapid solidification can be decreased and an effect of improving intrinsic coercive force HcJ can be obtained. However, when a ratio of substitution of C for B is more than 50%, the amorphous generation ability is greatly decreased unfavorably. Therefore, the ratio of substitution of C for B is preferably in a range of 0% to 50%, i.e., 0.0≤n≤0.5. It should be noted that from the viewpoint of the effect of improving intrinsic coercive force HcJ, the ratio of substitution of C for B is preferably 2% to 30%, and is more preferably 3% to 15%.

In the magnet material for a bonded magnet according to the present invention, when composition ratio y of at least one rare-earth element RE containing at least Nd among Nd and Pr is less than 11.5 atomic %, the grain boundary phase containing F, RE, Fe, and B may not be generated, with the result that sufficient magnetic properties may be unable to be secured. On the other hand, when composition ratio y is more than 13.0 atomic %, magnetization may be decreased. Therefore, composition ratio y is preferably in a range of 11.5 atomic % to 13.0 atomic %. It should be noted that F contained in the grain boundary phase is contained in Nd and/or Pr. That is, F is contained in a Nd metal (Nd content is 95 weight % or more), Pr metal (Pr content is 95 weight % or more), or Nd—Pr metal (a weight ratio of Nd/Pr is 3.4 to 4.9 weight %, and the sum of Nd and Pr is 95 weight % or more), each of which is a source material for manufacturing. Further, from the viewpoint of stably securing intrinsic coercive force HcJ, composition ratio y is preferably 11.76 atomic % to 13.0 atomic %, which is a stoichiometric composition of the RE₂Fe₁₄B type tetragonal compound, and is more preferably 11.76 atomic % to 12.5 atomic % from the viewpoint of securing a high residual magnetic flux density Br, for example.

Further, rare earth RE may be RE_{y}=(Nd₁₋₁Pr₁)_{y} in order to obtain higher intrinsic coercive force HcJ, and in this case, 1 is preferably set to 0.05 to 0.7. It should be noted that when ratio of substitution 1 of Pr to Nd is too low, the effect of improving HcJ is small, whereas when 1 is too high, the absolute value of a temperature coefficient β for the coercive force of the magnet alloy becomes small to presumably result in decreased thermal resistance, so that 1 is preferably 0.15 to 0.6 and is more preferably 0.2 to 0.5.

In the magnet material for a bonded magnet according to the present invention, one or more metal elements M selected from a group consisting of Al, Si, V, Cr, Ti, Mn, Cu, Zn, Ga, Zr, Nb, Mo, Ag, Hf, Ta, W, Pt, Au, and Pb may be added. By the addition of metal elements M, effects are obtained such as improvement of the amorphous generation ability, improvement of intrinsic coercive force HcJ due to the metal structure after the crystallization heat treatment being uniformly fine, improvement of the squareness of the demagnetization curve, and the like, thereby improving the magnetic properties. However, when composition ratio z of these metal elements M is more than 5.0 atomic %, the magnetization may be decreased, so that composition ratio z is preferably in a range of 0.0 atomic % to 5.0 atomic %. Further, composition ratio z is preferably 0.0 atomic % to 4.0 atomic %, and is more preferably 0.0 atomic % to 3.0 atomic %.

### [Metal Structure]

In the magnet material for a bonded magnet according to the present invention, when the average crystal grain size of the RE₂Fe₁₄B type tetragonal compound, which is the main phase, is, for example, less than 10 nm, intrinsic coercive force HcJ may be decreased, whereas when the average crystal grain size is, for example, 70 nm or more, the squareness of the demagnetization curve may be decreased due to decreased exchange interaction between the crystal grains. Therefore, for example, in order to realize magnetic properties such as residual magnetic flux density Br of 0.85 T or more, intrinsic coercive force HcJ of 700 kA/m or more and less than 1400 kA/m, and maximum energy product (BH)max of 120 kJ/m³ or more, the average crystal grain size of the RE₂Fe₁₄B tetragonal compound is preferably in a range of 10 nm or more and less than 70 nm. Further, the average crystal grain size of the RE₂Fe₁₄B type tetragonal compound is preferably 15 nm to 60 nm, and is more preferably 15 nm to 50 nm.

The average crystal grain size of the RE₂Fe₁₄B type tetragonal compound means the average value of the equivalent circle diameters of the respective grains present in visual fields when the grain sizes of the grains are measured at three or more positions in accordance with a line-intercept method using a transmission electron microscope (TEM).

When the width of the grain boundary phase is, for example, less than 1 nm, binding force acting between the grains of the main phase may be increased to result in decreased intrinsic coercive force HcJ. On the other hand, when the width of the grain boundary phase is, for example, 10 nm or more, the binding between the grains may be conversely decreased to result in decreased squareness of the demagnetization curve. Therefore, the width of the grain boundary phase is preferably 1 nm or more and less than 10 nm, is more preferably 2 nm to 8 nm, and is further preferably 2 nm to 5 nm. It should be noted that the width of the grain boundary phase was found by performing image analysis on a bright-field image captured using a scanning transmission electron microscope under conditions of an acceleration voltage of 200 kV and an observation magnification of 900,000.

In the magnet material for a bonded magnet according to the present invention, the content of the main phase is preferably 70 volume % or more and less than 99 volume %, and the content of the grain boundary phase is preferably 1 volume % or more and less than 30 volume %. A ratio of coverage of an outer peripheral portion of the main phase with the grain boundary phase is preferably such that 40% or more and less than 99% of the peripheral length of the outer peripheral portion of the main phase is covered with the grain boundary phase. Thus, for example, it is more likely to attain the magnetic properties such as residual magnetic flux density Br of 0.85 T or more, intrinsic coercive force HcJ of 700 kA/m or more and less than 1400 kA/m, and maximum energy product (BH)max of 120 kJ/m³ or more. The ratio of the main phase is preferably 80 volume % or more and less than 99 volume %, and is more preferably 90 volume % or more and less than 98 volume %. It should be noted that the constituent ratio of the main phase and the grain boundary phase and the ratio of coverage of the outer peripheral portion of the main phase with the grain boundary phase are each found by performing image analysis on a bright-field image captured using a scanning transmission electron microscope under conditions of an acceleration voltage of 200 kV and an observation magnification of 900,000.

In the magnet material for a bonded magnet according to the present invention, F contained in the grain boundary phase contributes to formation of the amorphous grain boundary phase. The present inventor has found that the RE₂Fe₁₄B phase, which is the main phase, and the grain boundary phase, which is uniformly present around the main phase and contains F, RE, Fe and B as the main components, are bound together by magnetostatic interaction as well as strong exchange interaction and behave as if they were one hard magnetic phase, with the result that high maximum energy product (BH)max, due to high residual magnetic flux density Br and improvement of the squareness of the demagnetization curve, can be obtained without impairing intrinsic coercive force HcJ of the RE₂Fe₁₄B phase. In particular, it is considered that the inclusion of the grain boundary phase as described above contributes to exhibition of high intrinsic coercive force HcJ as described later.

### [Magnetic Properties]

The magnet material for a bonded magnet according to the present invention preferably exhibits the magnetic properties such as residual magnetic flux density Br of 0.82 T or more, intrinsic coercive force HcJ of 700 kA/m or more and less than 1400 kA/m, and maximum energy product (BH)max of 105 kJ/m³ or more, for example. Intrinsic coercive force HcJ is preferably 800 kA/m or more and is more preferably 950 kA/m or more in the case of a magnetic circuit configuration in which a reverse magnetic field is likely to be applied to a permanent magnet of a surface permanent magnet type rotor (SPM type rotor) or the like when used in each of various types of rotating machines optimal for electric components and household appliances and having about 1 horsepower (750 W) or less. It should be noted that when intrinsic coercive force HcJ is 1400 kA/m or more, the magnetization is significantly decreased, so that intrinsic coercive force HcJ is preferably 1300 kA/m or less and is more preferably 1250 kA/m or less. Further, when an interior permanent magnet type rotor (IPM type rotor) or the like is employed, it can be driven at a operating point (permeance) higher than that of the SPM type, and therefore residual magnetic flux density Br is preferably as high as possible; however, in consideration of balance between residual magnetic flux density Br and intrinsic coercive force HcJ, residual magnetic flux density Br is preferably 0.85 T or more and is more preferably 0.9 T or more.

It should be noted that residual magnetic flux density Br is preferably 0.82 T or more as one example due to the following reason: when applied to a direct-current brushless motor as an isotropic bonded magnet, the operating point (permeance Pc) of the magnet is about 3 to 10, and therefore, when residual magnetic flux density Br≥0.82 T, an effective magnetic flux Bm having a level comparable to that of an anisotropic Nd—Fe—B sintered magnet having a maximum energy product (BH)max of 300 kJ/m³ or more can be obtained in this Pc range. It should be noted that residual magnetic flux density Br is more preferably 0.86 T or more.

Intrinsic coercive force HcJ is preferably 700 kA/m or more as one example due to the following reason: in the case where intrinsic coercive force HcJ is less than 700 kA/m, when applied to a direct-current brushless motor as an isotropic bonded magnet, the motor cannot securely have a thermal resistance temperature of 100° C., with the result that a desired motor property may be unable to be obtained by thermal demagnetization. In addition, intrinsic coercive force HcJ is set to be less than 1400 kA/m due to the following reason: intrinsic coercive force HcJ of 1400 kA/m or more makes magnetization difficult, with the result that magnetization with multiple poles to secure Pc of 3 to 10 is difficult.

Further, maximum energy product (BH)max is preferably 105 kJ/m³ or more as one example due to the following reason: when maximum energy product (BH)max is less than 105 kJ/m³, the ratio of squareness of the demagnetization curve (residual magnetization Jr/saturation magnetization Js) is 0.8 or less, and therefore, when applied to a direct-current brushless motor as an isotropic bonded magnet, the magnetic properties are decreased by a reverse magnetic field generated during an operation of the motor, with the result that a desired motor property may be unable to be obtained.

### [Method of Manufacturing Magnet Material]

The magnet material for a bonded magnet according to the present invention can be manufactured, for example, as follows. First, a molten alloy having the above-described metal composition is prepared. Next, the molten alloy is sprayed, at an average exiting rate of 200 g/min or more and less than 2000 g/min per orifice disposed at a tip of the nozzle, onto a surface of a rotary roll containing, as a main component, Cu, Mo, W or an alloy containing at least one of these metals, thereby producing a rapidly solidified alloy having 1 volume % or more of one of a crystalline phase or amorphous phase each containing the RE₂Fe₁₄B phase. It should be noted that RE is at least one rare-earth element containing substantially no La and Ce; however, as one example, RE can be at least one rare-earth element containing at least Nd among Nd and Pr as described above. Details are as described above.

### [Rapid Cooling of Molten Metal]

In the method of manufacturing the magnet material according to the present invention, the rapidly solidified alloy having 1 volume % or more of one of the crystalline phase and amorphous phase each containing the RE₂Fe₁₄B phase is produced by melting source materials prepared to attain a predetermined alloy composition so as to obtain a molten alloy and then spraying, at an average exiting rate of 200 g/min or more and less than 2000 g/min per orifice disposed at the tip of the nozzle, the molten alloy onto the surface of the rotary roll containing, as a main component, Cu, Mo, W or an alloy containing at least one of the metals; however, when the average exiting rate is less than 200 g/min, productivity is insufficient, whereas when the average exiting rate is 2000 g/min or more, the rapidly solidified molten alloy structure contains a coarse α-Fe phase, with the result that the above-described magnetic properties may be unable to be obtained even when the crystallization heat treatment is performed. Therefore, the average exiting rate per orifice disposed at the tip of the nozzle is limited to the range of 200 g/min or more and less than 2000 g/min. It should be noted that the average exiting rate is preferably 300 g/min to 1500 g/min, and is more preferably 400 g/min to 1300 g/min.

The hole, which is disposed at the tip of the nozzle and from which the molten metal is exited, may not be the circular orifice, may have any shape such as a quadrangular shape, a triangular shape, or an elliptic shape, and may be in the form of a slit as long as the hole has a shape by which a predetermined exiting rate can be secured. In addition, a refractory material that does not or is less likely to react with the molten alloy is accepted as the material of the nozzle; however, a ceramic material, SiC, C or BN, by each of which the nozzle orifice is less damaged by the molten alloy that is being exited, is preferable, BN is more preferable, and hard BN containing an additive material is further preferable.

When producing the rapidly solidified alloy, a rapid solidification atmosphere is preferably an oxygen-free atmosphere or a low-oxygen atmosphere because an increase in the viscosity of the molten metal can be suppressed by preventing oxidation of the molten alloy and a stable exiting rate can be maintained. In order to realize such an atmosphere, it is preferable that a rapid solidification apparatus is vacuumed to 20 Pa or less, preferably 10 Pa or less, more preferably 1 Pa or less, then an inert gas is introduced into the rapid solidification apparatus to attain an oxygen concentration of 500 ppm or less, preferably 200 ppm or less, more preferably 100 ppm or less in the rapid solidification apparatus, and then the rapid solidification is performed. As the inert gas, a noble gas, such as helium or argon, or nitrogen can be used; however, since nitrogen is relatively likely to react with a rare-earth element and iron, the noble gas such as helium or argon is preferable, and the argon gas is more preferable in terms of cost.

In the step of producing the rapidly solidified alloy, the rotary roll, which contains, as a main component, Cu, Mo, W or an alloy containing at least one of these metals, for rapidly cooling the molten alloy preferably has a base member containing such a main component. This is because such a base member is excellent in thermal conductivity and durability. Further, by plating a surface of the base member of the rotary roll with Cr, Ni, or a combination thereof, thermal resistance and hardness of the surface of the base member of the rotary roll can be increased, thereby suppressing melting and deterioration of the surface of the base member of the rotary roll during the rapid solidification. It should be noted that the diameter of the rotary roll is, for example, Φ200 mm to Φ20000 mm. It is not necessary to water-cool the rotary roll when a time of the rapid solidification is a short time of 10 sec or less; however, when the time of the rapid solidification is more than 10 sec, cooling water is preferably caused to flow inside the rotary roll so as to suppress an increased temperature of the base member of the rotary roll. A water-cooling ability of the rotary roll is preferably calculated in accordance with latent heat of solidification per unit time and the exiting rate, and is preferably optimally adjusted as appropriate.

### [Flash Annealing]

The method of manufacturing the magnet material according to the present invention can further include a step of performing flash annealing to the rapidly solidified alloy such that the temperature is increased at a temperature increase rate of 10° C./sec or more and less than 200° C./sec to reach a certain temperature range of a crystallization temperature or more and 850° C. or less and then rapid cooling is performed after passage of 0.1 sec or more and less than 7 min. By this step of performing the flash annealing, it becomes possible to form the above-described metal structure even when the content concentration of B is lower than that in the stoichiometric composition of the RE₂Fe₁₄B type tetragonal compound.

When the temperature increase rate during the flash annealing (crystallization heat treatment) is less than 10° C./sec, a fine metal structure may not be obtained due to excessive grain growth, and intrinsic coercive force HcJ and residual magnetic flux density Br may be decreased. When the temperature increase rate is 200° C./sec or more, crystal grain growth may not be sufficiently achieved, the above-described metal structure may be unable to be formed, and the magnetic properties may be decreased as in the case where the temperature increase rate is less than 10° C./sec. Therefore, the temperature increase rate is preferably 10° C./sec or more and less than 200° C./sec, is more preferably 30° C./sec to 200° C./sec, and is further preferably 40° C./sec to 180° C./sec.

In this flash annealing (crystallization heat treatment), in order to obtain excellent magnetic properties, it is preferable to perform rapid cooling immediately after reaching the crystallization heat treatment temperature (holding temperature) in the certain temperature range of the crystallization temperature or more and 850° C. or less. More specifically, a holding time from the reaching of the crystallization heat treatment temperature to the rapid cooling is sufficient to be substantially 0.1 sec or more, and a holding time of 7 μmin or more is not preferable because the uniform fine metal structure is impaired and various magnetic properties are decreased. Therefore, the holding time is preferably 0.1 sec or more and less than 7 min, is more preferably 0.1 sec to 2 min, and is further preferably 0.1 sec to 30 sec.

In this flash annealing (crystallization heat treatment), it is preferable to cool the rapidly solidified alloy to 400° C. or less at a temperature decrease rate of 2° C./sec to 200° C./sec. When the temperature decrease rate is less than 2° C./sec, the crystal structure may become coarse, whereas when the temperature decrease rate is more than 200° C./sec, the alloy may be oxidized. Therefore, the temperature decrease rate is preferably 2° C./sec to 200° C./sec, is more preferably 5° C./sec to 200° C./sec, and is further preferably 5° C./sec to 150° C./sec.

An atmosphere of the flash annealing (crystallization heat treatment) is preferably an inert gas atmosphere in order to prevent oxidation of the rapidly solidified alloy. As the inert gas, a noble gas, such as helium or argon, or nitrogen can be used; however, since nitrogen is relatively likely to react with a rare-earth element and iron, the noble gas such as helium or argon is preferable, and the argon gas is more preferable in terms of cost.

### [Pulverization and Molding]

The method of manufacturing the magnet material for a bonded magnet according to the present invention may further include a step of producing a magnet powder by pulverizing the rapidly solidified alloy or the rapidly solidified alloy having been through the flash annealing.

The rapidly solidified alloy obtained through the above steps and in the form of a thin strip may be roughly cut or pulverized to, for example, 50 mm or less before the flash annealing (crystallization heat treatment). Further, the rapidly solidified alloy having been through the flash annealing (crystallization heat treatment) is pulverized into a powdery magnet material having an appropriate average grain size falling within a range from 20 μm to 200 μm, with the result that various resin-bound permanent magnets (commonly referred to as plastic magnets or bonded magnets) can be manufactured using this magnet material through a well-known process.

The permanent magnet of the present invention can be manufactured, for example, as follows. First, the powdery magnet material manufactured as described above is prepared. Next, a thermosetting resin is added to the magnet material, the magnet material is then introduced into a mold and is compression-molded to form a compression-molded body, and heat treatment is then performed at a temperature equal to or more than a polymerization temperature of the thermosetting resin.

Alternatively, after preparing the powdery magnet material, a thermoplastic resin can be added to the magnet material to produce a compound for injection molding, and then injection molding can be performed.

When producing the magnet, the powdery magnet material is mixed with, for example, epoxy, polyamide, polyphenylene sulfide (PPS), liquid crystal polymer, acrylic, polyether, or the like, and is molded into a desired shape. On this occasion, for example, a hybrid magnet powder obtained by mixing it with a permanent magnet powder such as a SmFeN-based magnet powder or a hard ferrite magnet powder may be used.

The above-described magnet can be used to manufacture various types of rotating machines, which can be applied to vehicles (including battery electric vehicles and hybrid electric vehicles) and household appliances, as a brushless DC motor having about 1 horsepower (750 W) or less, and can be used to manufacture various types of magnetic sensors.

When the powdery magnet material is used for an injection-molded bonded magnet, the magnet material is preferably pulverized to have an average grain size of 100 μm or less, and a more preferable average crystal grain size is 20 μm to 100 μm. When the magnet material is used for a compression-molded bonded magnet, the magnet material is preferably pulverized to have an average grain size of 200 μm or less, and a more preferable average crystal grain size is 50 μm to 150 μm. Further preferably, the magnet material has two peaks in grain size distribution and has an average crystal grain size of 80 μm to 130 μm.

It should be noted that regardless of a molding method, the moldability of the resin-bound permanent magnet during molding and the corrosion resistance and thermal resistance of the obtained resin-bound permanent magnet can be improved by performing surface treatment such as coupling treatment or chemical conversion treatment (including phosphoric acid treatment and glass coating treatment) onto the surface of the magnet material for a bonded magnet according to the present invention. Also when surface treatment such as resin coating, chemical conversion treatment, or plating is performed onto the resin-bound permanent magnet having been molded, the corrosion resistance and thermal resistance of the resin-bound permanent magnet can be improved in the same manner as in the surface treatment of the magnet alloy powder.

It should be noted that the method of manufacturing the magnet material for a bonded magnet according to the present invention is not limited to the above-described method, and another manufacturing method can be employed as long as a magnet material having the above-described composition, average crystal grain size, and the like can be manufactured. For example, the flash annealing can be used to form the fine metal structure containing, as a main phase, the RE₂Fe₁₄B type tetragonal compound having an average crystal grain size of 10 nm or more and less than 70 nm; however, the method of forming such a fine metal structure is not limited to the flash annealing and another method can be employed. For example, even when an ordinary annealing process, rather than the flash annealing, is employed, excellent magnetic properties can be obtained if a surface speed of the rotary roll for rapidly cooling the molten alloy is adjusted to allow the rapidly solidified alloy structure to have a homogeneous fine metal structure composed of crystal grains smaller by about 5% to 20% than those in an alloy structure allowing for optimal magnetic properties.

### EXAMPLES

Hereinafter, examples of the present invention will be described. It should be noted that the present invention is not limited to only these examples.

### EXAMPLES

100 g of a source material having main elements, i.e., Nd, Pr, Dy, B, C and Fe each with a purity of 99.5% or more as well as an additive element such as Co, Al, Si, V, Cr, Ti, Mn, Cu, Zn, Ga, Zr, Nb, Mo, Ag, Hf, Ta, W, Pt, Au or Pb was introduced into a melting crucible composed of alumina and the melting crucible was set to a work coil in a vacuum melting furnace so as to attain each of below-described alloy compositions shown in Table 1. Then, the vacuum melting furnace was vacuumed to 0.02 Pa or less, then an argon gas was introduced to attain normal pressure, and high-frequency induction heating is performed, thereby obtaining a molten alloy. Then, the molten alloy was casted in a water-cooled copper mold, thereby producing a mother alloy.

Next, the obtained mother alloy was divided into an appropriate size, 40 g of the mother alloy was then inserted into a transparent quartz nozzle having a bottom portion appropriately provided with orifices having different diameters (0.7 mm to 1.2 mm) so as to attain an average exiting rate of 200 g/min or more and less than 2000 g/min, and then the transparent quartz nozzle was set in a work coil in a single-roll rapid cooling apparatus. Then, the vacuum melting furnace was vacuumed to 0.02 Pa or less, an argon gas was then introduced to attain a rapid cooling atmosphere pressure (40 to 65 kPa), the mother alloy was melted again by high-frequency induction heating, and then the molten alloy was exited from the nozzle orifices at a spraying pressure of 30 kPa onto the surface of the rotary roll rotating at a surface speed of 50 to 70 m/s, thereby producing a rapidly solidified alloy. The above method is referred to as a melt spinning method. It should be noted that on this occasion, a distance between the tip of the nozzle and the surface of the rotary roll was 0.8 mm. Further, the main component of the rotary roll was copper. Further, the obtained rapidly solidified alloy had 1 volume % or more of one of a crystalline phase or amorphous phase each containing a Nd₂Fe₁₄B phase.

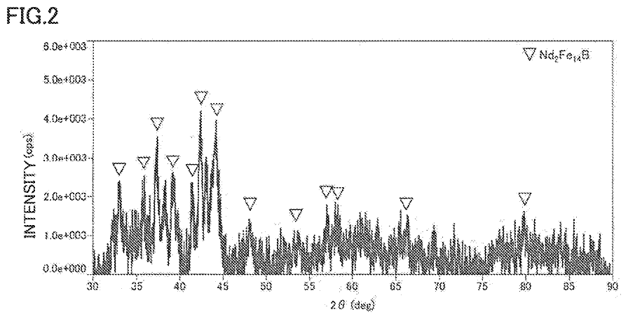

As a representative example, FIG. 2 shows a powder X-ray diffraction profile of a rapidly solidified alloy obtained in an Example 5. In view of FIG. 2, it was confirmed that the Nd₂Fe₁₄B phase was already present in the rapid solidification state.

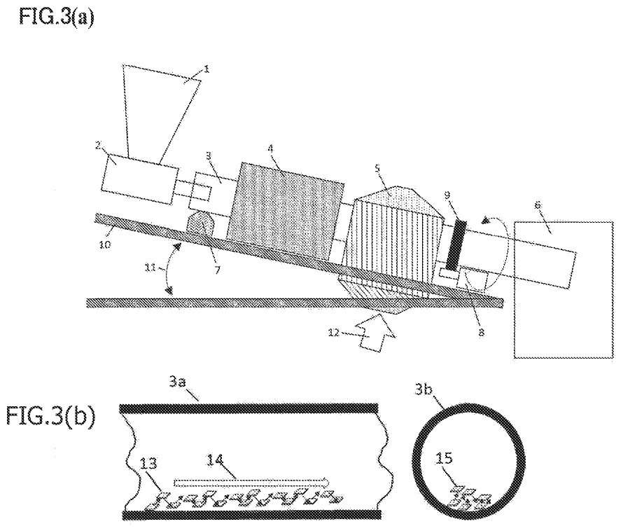

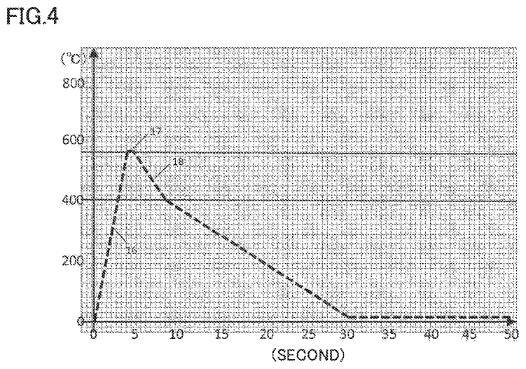

The rapidly solidified alloy obtained by the above steps was roughly pulverized to several mm or less to obtain a rapidly solidified alloy powder, and then the rough rapidly solidified alloy powder was introduced into a source material hopper using a flash annealing furnace (crystallization heat-treatment furnace with a furnace core tube composed of transparent quartz and having an outer diameter of 15 mm×an inner diameter of 12.5 mm×a length of 1000 mm, a heating zone of 300 mm, and a cooling zone of 500 mm by a cooling fan), and heat treatment was performed at a workpiece cutting speed of 20 g/min. It should be noted that for a furnace core tube inclination angle, a furnace core tube rotation speed, and a furnace core tube vibration frequency, heat treatment temperature was set to 550° C. to 750° C. and heat treatment time was set to 10 sec to 30 sec so as to attain a temperature increase rate of 10 to 200° C./sec. Thus, the rapidly solidified alloy powder passed through the furnace core tube while moving in combination of stirring by the rotation movement of the furnace core tube and a hopping phenomenon by the vibration of the furnace core tube, with the result that the rapidly solidified alloy powder was placed under a peculiar heat treatment condition in which each of individual powder particles of the rapidly solidified alloy powder, rather than a whole of the rapidly solidified alloy powder, undergoes thermal history. FIG. 3 and FIG. 4 show exemplary heat treatment furnace and thermal history in the step of performing the flash annealing.

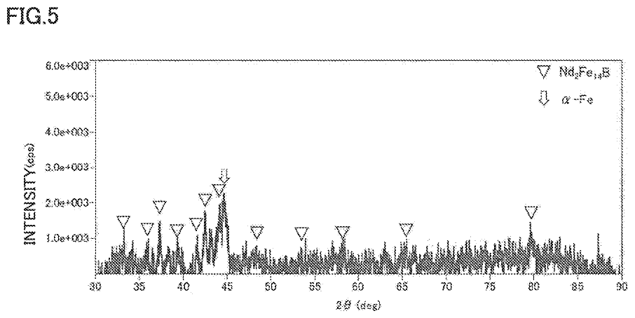

When the constituent phase of the rapidly solidified alloy powder after the flash annealing (crystallization heat treatment) was checked through powder X-ray diffraction, the presence of the Nd₂Fe₁₄B phase was confirmed. As a representative example, FIG. 5 shows a powder X-ray diffraction profile of the rapidly solidified alloy obtained in Example 5 after the flash annealing (crystallization heat treatment).

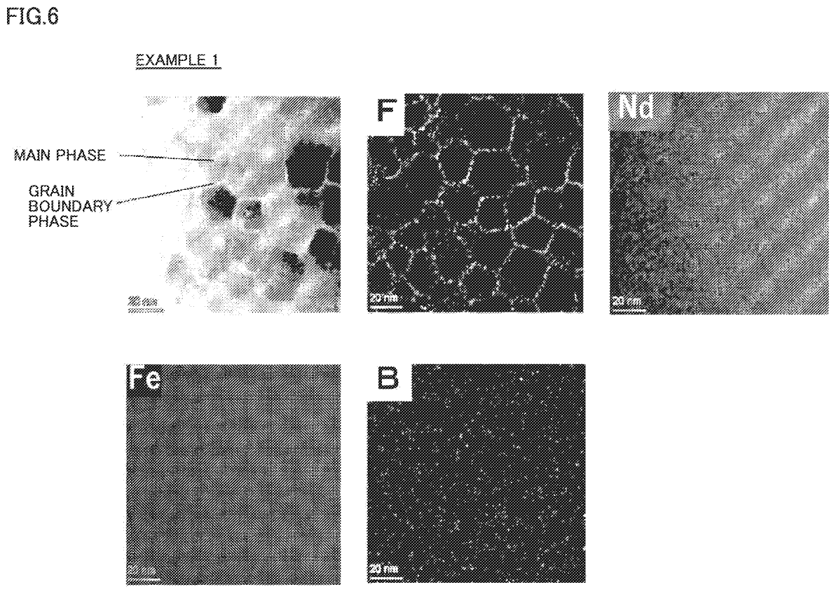

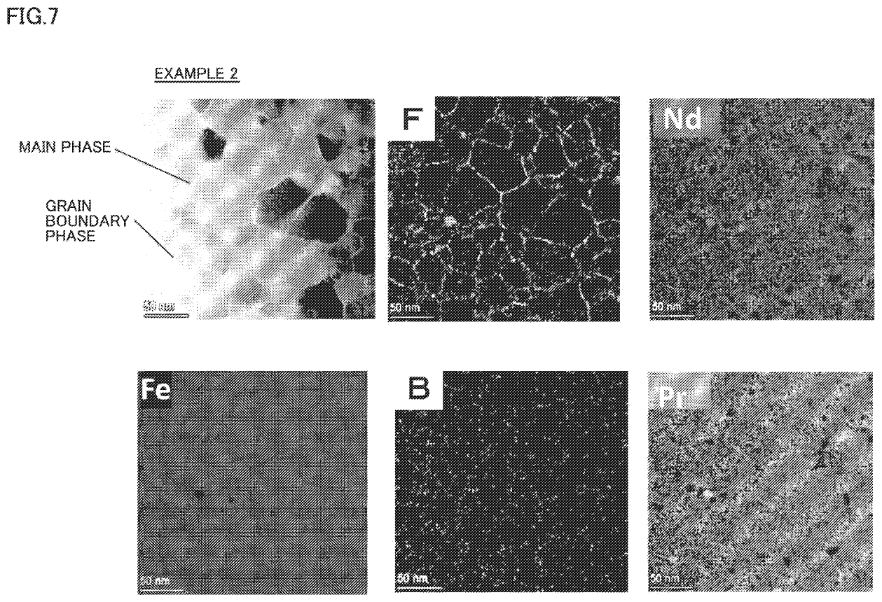

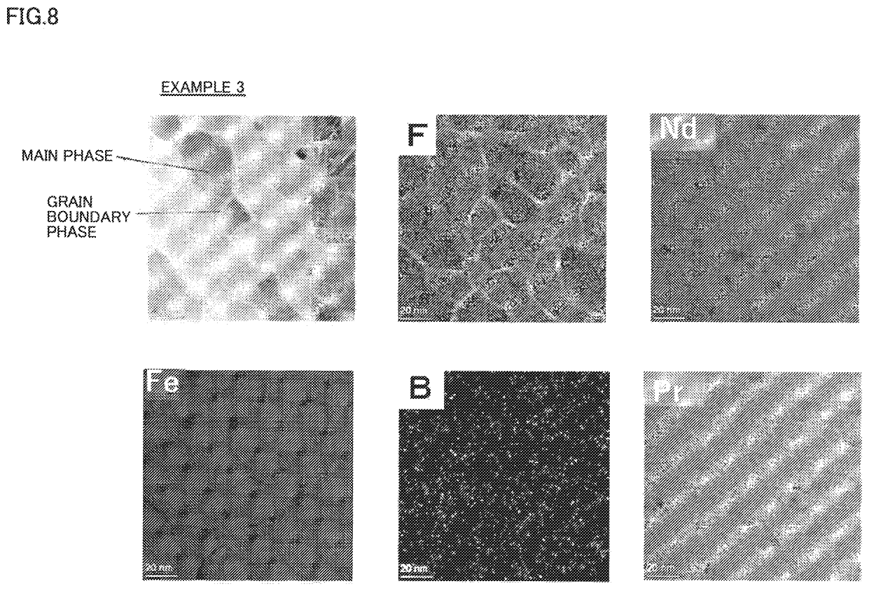

Each of FIGS. 6 to 8 shows a bright-field image obtained by observing each of the magnet materials obtained in Examples 1 to 3 using a transmission electron microscope and shows element mapping through energy dispersive X-ray spectroscopy. From the bright-field image, it was confirmed that the Nd₂Fe₁₄B phase having an average crystal grain size of 50 nm or less and a clear grain boundary phase surrounding the Nd₂Fe₁₄B phase were present. Further, in the element mapping, it was confirmed that the grain boundary phase in which F and Nd or Pr were concentrated was present in the grain boundary of the main phase composed of the main constituent elements, i.e., Nd, Fe, and B. For example, in the element mapping of F, it is understood that portions indicated by white represent F and are distributed along the grain boundary phase. It should be noted that the present inventor has confirmed that the grain boundary phase as shown in each of FIGS. 6 to 8 is formed in all the Examples. For analysis of B, electron energy loss spectroscopy or the like may be used as required.

As described above, the magnet material obtained by performing the flash annealing (crystallization heat treatment) was used as a magnetic-property evaluation sample having a length of about 7 mm×a width of about 0.9 mm to 2.3 mm×a thickness of 18 μm to 25 μm, and was then magnetized in the longitudinal direction by a pulse-applied magnetic field of 3.2 MA/m. Then, the magnetic properties at room temperature were measured using a vibrating sample magnetometer (VSM) with the magnetic-property evaluation sample being set in the longitudinal direction in order to suppress an influence of demagnetizing field, and results of the measurement are shown in Table 2. In particular, in each of Examples 2 and 3 containing Pr, it was found that higher intrinsic coercive force HcJ than those in the other Examples was obtained.

Next, the magnetic powder having been through the flash annealing (crystallization heat treatment) as obtained in Example 5 was pulverized by a pin disc mill so as to attain an average grain size of 125 μm. Then, 2 μmass % of an epoxy resin diluted with methyl ethyl ketone (MEK) was added to the pulverized magnetic powder, mixing and kneading were performed, and 0.1 μmass % of calcium stearate was then added as a lubricant, thereby producing a compound for a compression-molded bonded magnet.

The above-described compound for a compression-molded bonded magnet was compression-molded at a pressure of 1568 MPa (16 ton/cm²) to obtain a compression-molded body having a shape with a diameter of 10 mm×a height of 7 mm, and then the compression-molded body was subjected to curing heat treatment (curing) at 180° C. for one hour in an argon gas atmosphere, thereby obtaining an isotropic compression-molded bonded magnet. It should be noted that since the density of the molded body of the obtained isotropic compression-molded bonded magnet was 6.3 g/cm³ (the true specific gravity of the magnetic powder was 7.5 g/cm³), a magnetic powder packing ratio was 84 volume %.

When the magnetic properties of the isotropic compression-molded bonded magnet obtained by using the magnetic powder of Example 5 were measured using a BH tracer after being magnetized in the longitudinal direction using a pulse-applied magnetic field of 3.2 MA/m, it was found that the following magnetic properties were exhibited: residual magnetic flux density Br of 0.74 T, intrinsic coercive force HcJ of 1028 kA/m, and maximum energy product (BH)max of 89.4 kJ/m³.

Next, the magnetic powder having been through the flash annealing (crystallization heat treatment) as obtained in Example 5 was pulverized to have an average grain size of 75 μm by a pin disc mill. Then, coupling treatment was performed by spraying a titanate-based coupling agent to attain 0.75 μmass % while heating and stirring the pulverized magnetic powder, 0.5 μmass % of amide stearate and 4.75 μmass % of nylon 12 resin powder were added and mixed as lubricants, and then a compound for an injection-molded bonded magnet was produced at an extrusion temperature of 170° C. using a continuous extrusion kneader.

Injection molding was performed at an injection temperature of 250° C. using the compound for an injection-molded bonded magnet, thereby producing an isotropic injection-molded bonded magnet having a shape with a diameter of 10 mm×a height of 7 mm. It should be noted that since the density of the molded body of the obtained isotropic injection-molded bonded magnet was 4.6 g/cm³ (the true specific gravity of the magnetic powder was 7.5 g/cm³), a magnetic powder packing ratio was 61 volume %.

When the magnetic properties of the isotropic injection-molded bonded magnet obtained by using the magnetic powder of Example 5 were measured by a BH tracer after being magnetized in the longitudinal direction using a pulse-applied magnetic field of 3.2 MA/m, it was found that residual magnetic flux density Br of 0.54T, intrinsic coercive force HcJ of 1014 kA/m, and maximum energy product (BH)max of 63.4 kJ/m³ were exhibited, and therefore the magnetic properties having levels comparable to those of a general-purpose isotropic Nd—Fe—B compression-molded bonded magnet were obtained even in the case of the injection molding.

### Comparative Example

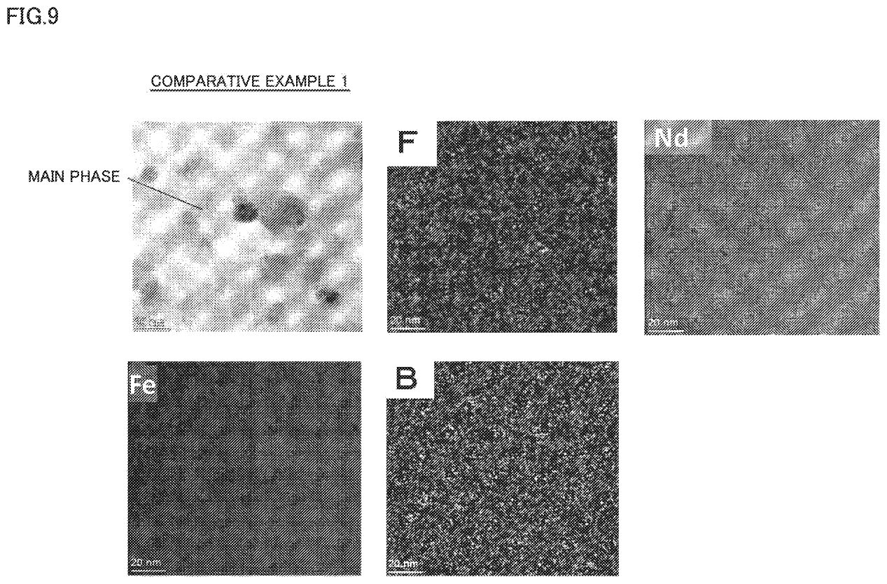

As a magnet material according to a Comparative Example, MQP-14-12 provided by Magnequench was prepared. FIG. 9 shows a bright-field image and element mapping when the magnet material according to the Comparative Example is observed using a transmission electron microscope. In the bright-field image, a Nd₂Fe₁₄B phase having an average crystal grain size of 50 nm or less could be confirmed, but a clear grain boundary phase could not be confirmed. Further, from the element mapping, it was also found that a grain boundary phase in which F and Nd or Pr were concentrated as observed in each of the Examples of the present invention was not present in the grain boundary of the main phase composed of the main constituent elements, i.e., Nd, Fe, and B.

Further, the magnet material according to the Comparative Example was used as a magnetic-property evaluation sample having a length of about 7 mm×a width of about 0.9 mm to 2.3 mm×a thickness of 18 μm to 25 μm, and was then magnetized in the longitudinal direction by a pulse-applied magnetic field of 3.2 MA/m. Then, the magnetic properties at room temperature were measured using a vibrating sample magnetometer (VSM) with the magnetic-property evaluation sample being set in the longitudinal direction in order to suppress an influence of demagnetizing field, and results of the measurement are shown in Table 2. From Table 2, it was found that intrinsic coercive force HcJ was particularly lower than those of the Examples of the present invention.

TABLE 1

| | at % | at % | at % | at % | at % | at % | at % | at % | at % | at % | at % | ppm |
|---|---|---|---|---|---|---|---|---|---|---|---|---|
| | Nd | Pr | Fe | Co | B | C | T [symbol] | Ta | Nb | V | Cr | F |
| Example 1 | 12.8 | | Remainder | [symbol] .1 | [symbol] | | 0.5 | | | | | [symbol] |
| Example 2 | 6.1 | 6 | Remainder | | 4.9 | | | | 2 | | | 16 |
| Example 3 | [symbol] .3 | 6.4 | Remainder | | 4.5 | | | | | | | 15 |
| Example 4 | 12.1 | | Remainder | | 4. [symbol] | 0.3 | | | | | | 17 |
| Example 5 | 12.7 | | Remainder | | 4.9 | | 0.5 | | | | | 20 |
| Example 6 | 12 | | Remainder | | 5 | | | | | 1 | | 17 |
| Example 7 | 12 | | Remainder | | 5 | | | | | | 1 | 1 [symbol] |
| Example 8 | 12 | | Remainder | | 5 | | | 5 | | | | 14 |

[symbol]

indicates data missing or illegible when filed

TABLE 2

| | Br (T) | Hcj (kA/m) | BHmax (kJ/m³) |
|---|---|---|---|
| Example 1 | 0.86 | 1052 | 124.7 |
| Example 2 | 0.86 | 1202 | 120.3 |
| Example 3 | 0.82 | 1230 | 105.6 |
| Example 4 | 0.91 | 1044 | 134.2 |
| Example 5 | 0.88 | 1040 | 128.3 |
| Example 6 | 0.87 | 1022 | 121.1 |
| Example 7 | 0.88 | 1038 | 123.9 |
| Example 8 | 0.87 | 1133 | 120.2 |
| Comparative | 0.84 | 978 | 120.2 |
| Example | | | |

### REFERENCE SIGNS LIST

1: source material hopper
2: source material supply feeder
3: furnace core tube
3a: enlarged view of a furnace core tube
3b: enlarged cross sectional view of the furnace core tube
4: tubular furnace
5: cooling tower
6: collection hopper
7: vibrator
8: motor for rotating the furnace core tube
9: furnace core tube rotation shaft
10: apparatus base
11: furnace core tube inclination angle
12: cooling fan air
13: rapidly solidified alloy powder (workpiece)
14: workpiece moving direction
15: workpiece hopping phenomenon
16: temperature increase rate
17: holding temperature
18: temperature decrease rate
21: main phase
22: grain boundary phase

1. A magnet material for a bonded magnet, the magnet material comprising:
a RE₂Fe₁₄B tetragonal compound as a main phase, the RE₂Fe₁₄B tetragonal compound has an average crystal grain size of 10 nm or more and less than 70 nm; and
an amorphous and magnetic grain boundary phase surrounding the main phase, the amorphous and magnetic grain boundary phase containing F, RE, Fe, and B,
wherein the RE is at least one rare-earth element containing at least Nd among Nd and Pr.

2. The magnet material for a bonded magnet according to claim 1, wherein the RE contains Nd and Pr.

3. The magnet material for a bonded magnet according to claim 1, wherein a width of the grain boundary phase is 1 nm or more and less than 10 nm.

4. The magnet material for a bonded magnet according to claim 3, wherein the width of the grain boundary phase is 2 nm to 8 nm.

5. The magnet material for a bonded magnet according to claim 1, wherein
a content of the main phase is 70 volume % to 99 volume %, and
a content of the grain boundary phase is 1 volume % to 30 volume %.

6. The magnet material for a bonded magnet according to claim 1, wherein the average crystal grain size of the RE₂Fe₁₄B tetragonal compound is 15 nm to 60 nm.

7. The magnet material for a bonded magnet according to claim 1, further comprising one or more metal elements M selected from a group consisting of Al, Si, V, Cr, Ti, Mn, Cu, Zn, Ga, Zr, Nb, Mo, Ag, Hf, Ta, W, Pt, Au, and Pb.

8. A magnet comprising:
a binder; and
the magnet material for a bonded magnet according to claim 1 dispersed in the binder.

9. The magnet according to claim 8, wherein the RE contains Nd and Pr.

10. The magnet according to claim 8, wherein a width of the grain boundary phase in the magnet material is 1 nm or more and less than 10 nm.

11. The magnet according to claim 10, wherein the width of the grain boundary phase is 2 nm to 8 nm.

12. The magnet according to claim 8, wherein, in the magnet material,
a content of the main phase is 70 volume % to 99 volume %, and
a content of the grain boundary phase is 1 volume % to 30 volume %.

13. The magnet according to claim 8, wherein the average crystal grain size of the RE₂Fe₁₄B tetragonal compound in the magnet material is 15 nm to 60 nm.

14. The magnet according to claim 8, wherein the magnet material further comprises one or more metal elements M selected from a group consisting of Al, Si, V, Cr, Ti, Mn, Cu, Zn, Ga, Zr, Nb, Mo, Ag, Hf, Ta, W, Pt, Au, and Pb.
